(19) United States
(12) Patent Application Publication
(10) Pub. No.: US 2012/0013549 A1
(43) Pub. Date: Jan. 19, 2012

(54) TOUCH SCREEN

(75) Inventors: Jae Il Kim, Gyunggi-do (KR); Yong Soo Oh, Gyunggi-do (KR); Jong Young Lee, Gyunggi-do (KR); Woon Chun Kim, Gyunggi-do (KR)

(73) Assignee: SAMSUNG ELECTRO-MECHANICS CO., LTD., Gyunggi-do (KR)

(21) Appl. No.: 12/901,776

(22) Filed: Oct. 11, 2010

(30) Foreign Application Priority Data
Jul. 14, 2010 (KR) 1020100068065

(51) Int. Cl. G06F 3/041

(52) U.S. Cl. 345/173

(57) ABSTRACT

Disclosed herein is a touch screen, including: a pair of base members that are spaced apart from each other by a spacer having an opening formed inside thereof and have resistive films formed on the opposite surfaces thereof; grooves that are each formed in outer regions of the resistive films formed on the pair of base members to intersect with each other and are extended from the upper surfaces of the resistive films to the base members in a thickness direction; and sensing electrodes that are formed in the outer regions of the resistive films to cover the grooves and are filled in the grooves.

### CROSS REFERENCE TO RELATED APPLICATION

This application claims the benefit of Korean Patent Application No. 10-2010-0068065, filed on Jul. 14, 2010, entitled “Touch Screen”, which is hereby incorporated by reference in its entirety into this application.

### BACKGROUND OF THE INVENTION

1. Technical Field

The present invention relates to a touch screen.

2. Description of the Related Art

With the development of a mobile communication technology, user terminals such as cellular phones, PDAs, and navigations can serve as a display unit that simply displays character information as well as a unit for providing various and complex multi-media such as audio, moving picture, radio internet web browser, etc. Therefore, electronic information terminals having a limited size require a larger display screen, such that a display device using a touch screen has become the main focus.

In addition, a touch screen combines a screen and coordinate input units, thereby saving space as compared to a key input scheme according to the prior art. Therefore, a display apparatus recently developed uses a touch screen in order to more improve a screen size and user convenience.

A touch screen is classified into a resistive type and a capacitive type. A resistive touch screen includes a pair of base members that are spaced apart from each other by a spacer having an opening formed inside thereof and have resistive films formed on the opposite surfaces thereof, and sensing electrode that is formed in the outer regions of the resistive films to sense change in voltage generated from the resistive films. In the resistive touch screen according to the prior art, the sensing electrodes are formed by patterning silver (Ag) paste on the resistive films, thereby causing a problem that the sensing electrodes are separated from the resistive films as time elapses.

Such a problem also occurs in sensing electrodes formed in the outer regions of electrode patterns of a capacitive touch screen.

### SUMMARY OF THE INVENTION

The present invention has been made in an effort to provide a touch screen that includes grooves that are formed in the outer regions of the resistive films or the electrode patterns to reach from the upper surfaces of resistive films or electrode patterns to base members, and sensing electrodes that are formed on the upper surfaces of the resistive films or the electrode patterns and are filled in the grooves so as to improve adhesion between the resistive films or the electrode patterns and the sensing electrodes.

A touch screen according to an embodiment of the present invention includes: a pair of base members that are spaced apart from each other by a spacer having an opening formed inside thereof and have resistive films formed on the opposite surfaces thereof; grooves that are each formed in outer regions of the resistive films formed on the pair of base members to intersect with each other and are extended from the upper surfaces of the resistive films to the base members in a thickness direction; and sensing electrodes that are formed in the outer regions of the resistive films to cover the grooves and are filled in the grooves.

The touch screen further includes signal transfer wirings that are connected to the sensing electrodes to transfer the change in voltage of the resistive films.

The grooves are formed along the outer regions of the resistive films at the same interval.

The groove passes through the base member.

The groove has a slit shape formed along the outer region of the resistive film.

The resistive film is made of a conductive polymer.

A touch screen according to an embodiment of the present invention includes: a pair of base members that are spaced apart from each other by a spacer and have a plurality of electrode patterns formed on the opposite surfaces thereof to intersect with each other; grooves that are formed in outer regions of the electrode patterns and are extended from the upper surfaces of the electrode patterns to the base members in a thickness direction; and sensing electrodes that are formed in the outer regions of the electrode patterns to cover the grooves and are filled in the grooves.

The touch screen further includes signal transfer wirings that are connected to the sensing electrodes to transfer the change in capacitance of the electrode patterns.

The groove passes through the base member.

The electrode pattern is made of a conductive polymer.

### BRIEF DESCRIPTION OF THE DRAWINGS

FIG. 1 is an exploded perspective view of a touch screen according to a first preferred embodiment of the present invention;

FIG. 2 is a plan view showing a portion of the touch screen of FIG. 1;

FIG. 3 is a cross-sectional view of the touch screen of FIG. 2;

FIG. 4 is a plan view showing a modified example of a touch screen according to a first preferred embodiment of the present invention;

FIG. 5 is a cross-sectional view of the touch screen of FIG. 4;

FIG. 6 is a cross-sectional view showing another modified example of a touch screen according to a first preferred embodiment of the present invention;

FIG. 7 is an exploded perspective view of a touch screen according to a second preferred embodiment of the present invention;

FIG. 8 is a plan view showing a portion of the touch screen of FIG. 7; and

FIG. 9 is a cross-sectional view of the touch screen of FIG. 7.

### DESCRIPTION OF THE PREFERRED EMBODIMENTS

Various features and advantages of the present invention will be more obvious from the following description with reference to the accompanying drawings.

The terms and words used in the present specification and claims should not be to interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

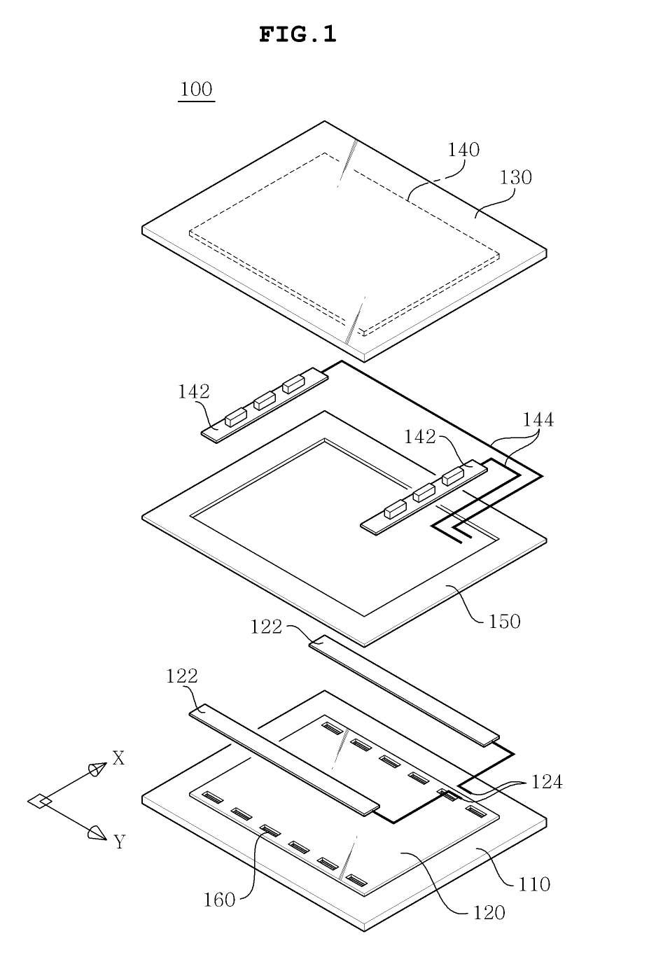

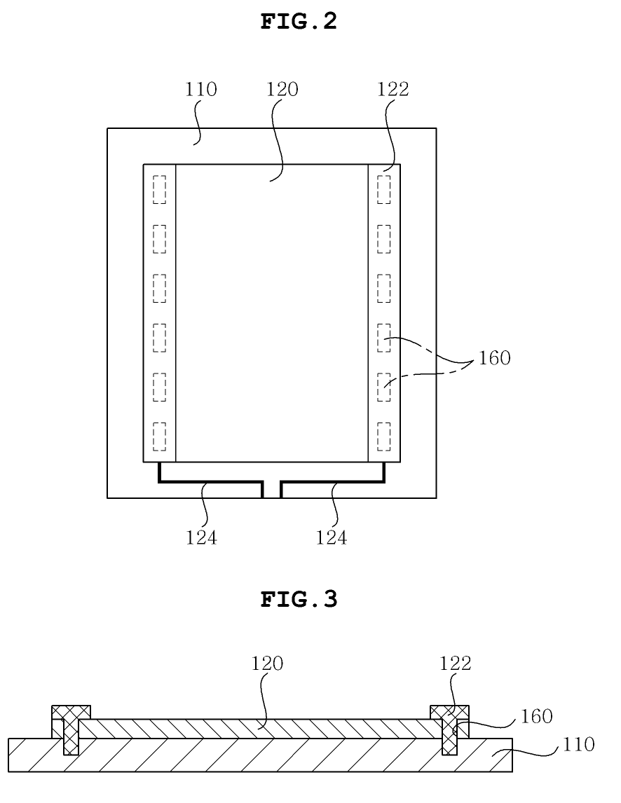

FIG. 1 is an exploded perspective view of a touch screen according to a first preferred embodiment of the present invention, FIG. 2 is a plan view showing a portion of the touch screen of FIG. 1, and FIG. 3 is a cross-sectional view of the touch screen of FIG. 2. Hereinafter, a touch screen according to the present embodiment will be described with reference to these figures.

In the touch screen according to a first preferred embodiment of the present invention, resistive films spaced apart from each other contact each other by external pressure to change voltage and a controller measures the change in voltage to calculate coordinates of a touched point. In order to improve adhesion between the resistive films and sensing electrodes, the touch screen according to the present embodiment includes grooves formed to reach from upper surfaces of the resistive films to base members and the sensing electrodes formed on the upper surfaces of the resistive films to be filled in the grooves.

The touch screen 100 according to the present embodiment will be described in a) detail with reference to FIG. 1. The touch screen 100 includes a pair of base members 110 and 130 having resistive films 120 and 140 formed on the opposite surfaces thereof, wherein the resistive films 120 and 140 are spaced apart from each other by a spacer 150 having an opening formed inside thereof.

The base members 110 and 130 may use a glass substrate, a film substrate, a fiber substrate, and a paper substrate. Among them, the film substrate may be made of polyethylene terephthalate (PET), polymethylmethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefin copolymer (COC), stylene polymer, polyethylene, polypropylene, etc., and are not specifically limited.

The resistive films 120 and 140 are formed in active regions (a region through which an image generated from a display passes) of the base members 110 and 130, wherein the resistive film is made of a transparent conductive material. For example, a metal oxide such as ITO may be applied.

In this case, the resistive films 120 and 140 are preferably applied with a transparent conductive polymer, wherein the conductive polymer may include an organic compound, such as polythiophene, polypyrrole, polyaniline, polyacetylene, polyphenylene polymers. In particular, among the polythiophene, a poly-3,4-ethylenedioxythiophene/polystyrenesulfonate (PEDOT/PSS) compound is most preferable and at least one of the organic compounds may be mixed. The conductive polymer has a low manufacturing unit cost, and in particular, the PEDOT/PSS compound has excellent conductivity and thus is most appropriate.

The spacer 150 has an opening formed inside thereof so that the resistive films 120 and 140 disposed opposite to each other are in contact with each other by external pressure. The spacer 150 may use a double-sided adhesive sheet. The spacer 150 may be bonded to a transparent member having an opening formed inside thereof by an optically clear adhesive.

The sensing electrodes 122 and 142 are connected to the resistive films so as to sense the change in voltage generated as the resistive films are in contact with each other. The sensing electrodes 122 and 142 are formed in the outer regions of the resistive films so as not to interrupt the image generated from the display from passing through.

In addition, the sensing electrodes are formed to intersect with each other with respect to the pair of resistive films that are opposite to each other. For example, as shown in FIG. 1, if the sensing electrodes 122 disposed at the lower side are formed in the outer region of the resistive film in a Y direction, the sensing electrodes 142 disposed at the upper side are formed in the outer region of the resistive film in an X direction.

The sensing electrodes 122 and 142 are preferably made of a conductive material having a low resistance such as silver paste.

The touch screen according to the present invention includes grooves formed so as to improve adhesion with the sensing electrodes as described. This will be described in detail with reference to FIGS. 2 and 3. Meanwhile, although FIGS. 2 and 3 show the base member 110 disposed at the lower side, it is obvious to those skilled in the art that the same configuration may also be applied to the sensing electrodes 142 formed on the base member 130 disposed at the upper side.

The grooves 160 are formed in the outer region of the resistive film 120 formed on the base member 110, similar to the sensing electrodes 122. In this case, the groove 160 is formed to be extended from the upper surface of the resistive film 120 to the base member 110. In other words, the groove 160 is formed up to the base member 110 by passing through the resistive film 120. The groove 160 is formed by laser drilling.

As shown in FIGS. 2 and 3, the sensing electrodes 122 are formed in the outer region of the resistive film 120 so as to cover the grooves and are filled in the grooves 160, thereby improving the adhesion of the sensing electrode 122. Therefore, the sensing electrode 122 has a rectangular shape and has a protrusions formed on one surface thereof. The sensing electrode 122 has such a shape since the outer regions of the resistive film in which the grooves are formed are printed with the silver paste and the silver paste is filled in the grooves during the printing process.

Meanwhile, the process of forming the sensing electrode is not limited thereto. The touch screen may also be formed by separately forming the sensing electrodes having the shapes as shown in FIGS. 1 to 3 and then bonding them onto the resistive films in which the grooves are formed.

In the prior art, the sensing electrodes are formed only on the surface of the resistive film in a Y direction. However, in the present invention, the sensing electrodes 122 are formed on the surface of the resistive film and are filled in the grooves 160, thereby improving adhesion. The portions of the sensing electrodes 122, which are filled in the grooves 160 to be in contact with the base member 110, become an important factor in increasing adhesion of the sensing electrodes 122.

When the resistive film 120 is made of a conductive polymer, the sensing electrodes 122 and the conductive polymer have weak adhesion, such that the sensing electrodes 122 are frequently separated in the prior art. However, when the resistive film 120 is formed with the grooves 160 as described above, the sensing electrodes 122 are also in contact with the base member 110 to increase adhesion, such that such a problem can be solved.

It is preferable that the grooves 160 are formed along the outer side of the resistive film 120 at the same interval, as shown in FIG. 2. The grooves 160 formed at the same interval can minimize the damage of the base member 110 and uniformly bond the sensing electrodes 122. Meanwhile, the shape of the groove 160 may be modified.

Signal transfer wirings 124 and 144 are connected to the sensing electrodes 122 and 142 to transfer the change in voltage generated from the resistive films to a controller (not shown). The signal transfer wirings 124 and 144 may use a metal wiring or be made of the same material as the sensing electrodes 122 and 142 and be formed to be integral therewith.

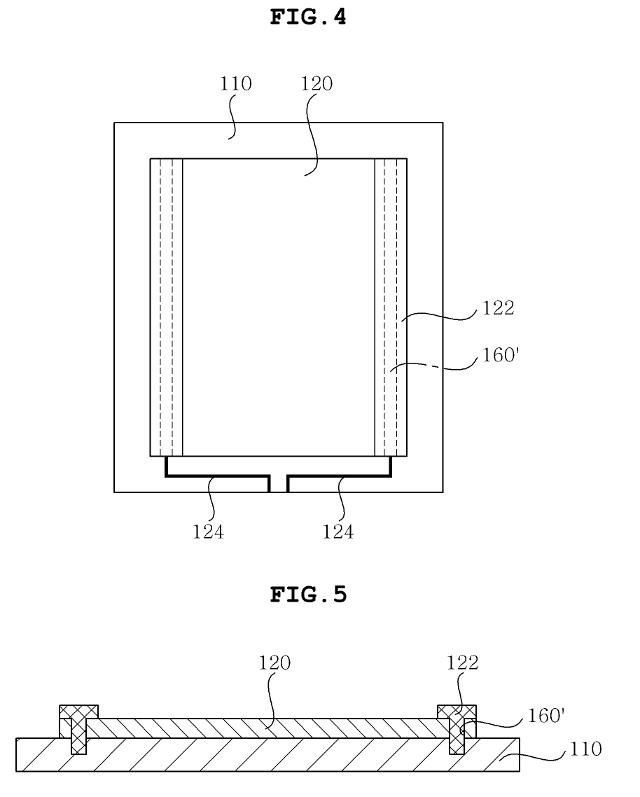

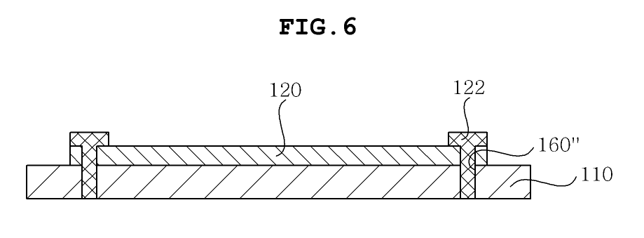

FIG. 4 is a plan view showing a modified example of a touch screen according to a first preferred embodiment of the present invention, FIG. 5 is a cross-sectional view of the touch screen of FIG. 4, and FIG. 6 is a cross-sectional view showing another modified example of a touch screen according to a first preferred embodiment of the present invention.

First, as shown in FIGS. 4 and 5, grooves 160′ are formed to have a slit shape along the outer side of the resistive film. The grooves 160′ are continuously formed from one side to the other side along the outer region of the resistive film 120 by laser drilling. A contact area of the sensing electrode 122 is further increased, such that the adhesion of the sensing electrode 122 is correspondingly increased.

In addition, as shown in FIG. 6, the grooves 160″ are formed to penetrate through the base member 110. The grooves 160″ having such a shape not only increases the contact area of the sensing electrode 122 but also better facilitates the formation of the sensing electrode 122 by passing air through the grooves 160″ when printing and drying a material such as silver paste.

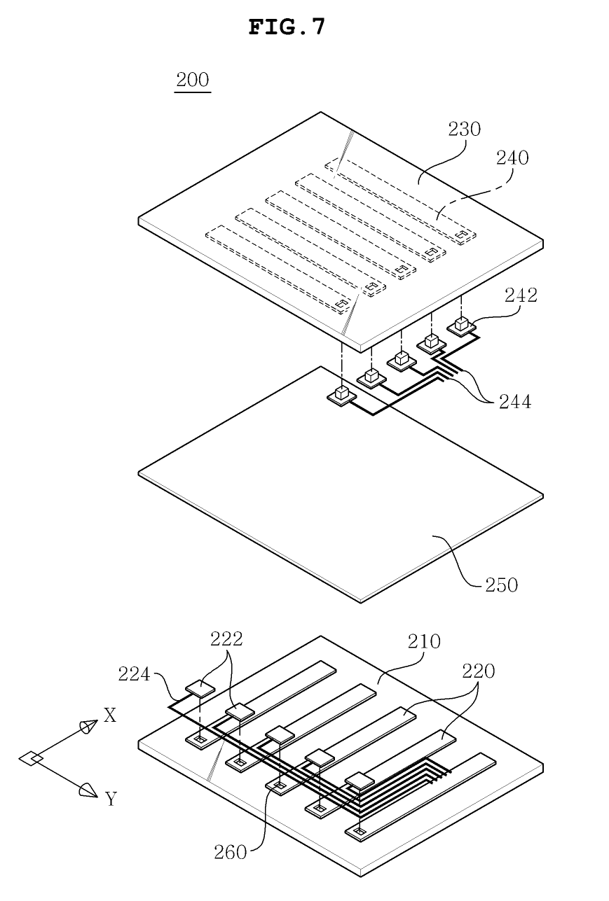

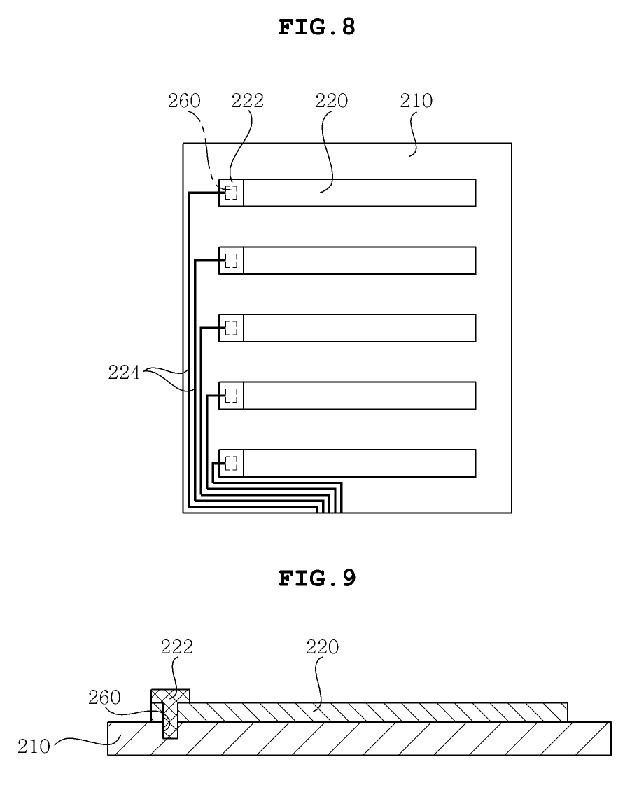

FIG. 7 is an exploded perspective view of a touch screen according to a second preferred embodiment of the present invention, FIG. 8 is a plan view showing a portion of the touch screen of FIG. 7, and FIG. 9 is a cross-sectional view of the touch screen of FIG. 7. Hereinafter, a touch screen according to the present embodiment will be described with reference to these figures. However, a detailed description of the same configuration as that described with reference to FIGS. 1 to 6 will be omitted.

When being touched by an input unit, a touch screen 200 according to the present embodiment measures the change in capacitance generated from electrode patterns to calculate coordinates of a touched point.

As shown in FIG. 7, the touch screen 200 includes a pair of base members 210 and 230 having a plurality of electrode patterns 220 and 240 formed on the opposite surfaces thereof to intersect with each other. The base member may use a glass substrate, a film substrate, or the like.

The electrode patterns 220 and 240 may be made of a transparent metal oxide such as ITO or a transparent conductive polymer. As shown in FIG. 7, the electrode patterns are formed, in parallel, to have a plurality of bar shapes. The electrode patterns 220 formed on the lower-side base member 210 is formed in an X direction and the electrode patterns 240 formed on the upper-side base member 230 are formed in a Y direction, which is described by way of one example, or vice versa.

In addition, even though the electrode pattern has a bar shape in FIG. 7, it may be modified so as to have a shape in which a polygonal sensing unit and a connection unit having a narrower width than the sensing unit are repeated. Therefore, the electrode pattern may also have a tooth shape.

A spacer 250 serves to allow the electrode patterns 220 and 240 disposed to be opposite to each other to be spaced apart from each other. The spacer 250 may use an OCA film and may be formed by bonding a transparent film substrate to the base members 210 and 230 by an optically clear adhesive.

Sensing electrodes 222 and 242 are connected to the electrode patterns to detect the change in capacitance generated from the electrode patterns. Even though the sensing electrodes 222 and 242 may be connected to one end of each of the electrode patterns 220 and 240 as shown in FIG. 7, they may also be connected to both ends of the electrode patterns, as needed.

The touch screen according to the present embodiment includes grooves 260 so as to improve adhesion with the sensing electrodes 222 and 242, similar to the touch screen described with reference to FIGS. 1 to 7.

Describing the grooves 260 in detail with reference to FIGS. 8 and 9, they are formed at ends of the electrode patterns, similar to the sensing electrodes 222. In this case, the groove 260 is formed to be extended from the upper surface of the electrode pattern 220 to the base member 210. In other words, the groove 260 is formed up to the base member 210 by passing through the electrode pattern 220.

Even though one groove 260 is formed for one sensing electrode 222 in FIG. 8, the number and the shape of the grooves may be modified.

The sensing electrode according to the prior art is formed on the upper surface of the electrode pattern, however, the sensing electrode 222 according to the present invention is formed on the upper surface of the electrode pattern 220 and is filled in the groove 260. Therefore, the sensing electrode 222 has a rectangular shape and has a protrusion formed on one surface thereof. The sensing electrode 222 filled in the groove 260 is in contact with the base member 210, thereby further increasing the adhesion.

In addition, the touch screen further includes signal transfer wirings 224 and 244 connected to the sensing electrodes 222 and 242, similar to the touch screen described with reference to FIGS. 1 to 6. The touch screen according to the present embodiment includes the plurality of sensing electrodes 222, such that the number of signal transfer wirings 224 and 244 is also increased. In order to facilitate the connection between the signal transfer wirings 224 and 244 and the connection unit such as a FPC, it is preferable that the distal ends of the signal transfer wirings 224 and 244 are collected at one point of the base members 210 and 230.

The touch screen according to the present invention includes grooves that are formed to reach from the upper surfaces of the resistive films or the electrode patterns to the base members, and the sensing electrodes that are formed on the upper surfaces of the resistive films or the electrode patterns and are also filled in the grooves, thereby making it possible to improve adhesion between the resistive films or the electrode patterns and the sensing electrodes. Therefore, it is possible to minimize the defect of the sensing electrodes even though the touch screen is used for a long period of time.

In addition, even though the resistive films or the electrode patterns are made of a conductive polymer, the touch screen according to the present invention can maintain adhesion between the resistive film or the electrode patterns and the sensing electrodes due to the grooves.

In addition, the touch screen according to the present invention forms the grooves to pass through the base members, thereby making it possible to shorten a dry process of the sensing electrodes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen, comprising:
a pair of base members that are spaced apart from each other by a spacer having an opening formed inside thereof and have resistive films formed on the opposite surfaces thereof;
grooves that are each formed in outer regions of the resistive films formed on the pair of base members to intersect with each other and are extended from the upper surfaces of the resistive films to the base members in a thickness direction; and
sensing electrodes that are formed in the outer regions of the resistive films to cover the grooves and are filled in the grooves.

2. The touch screen as set forth in claim 1, further comprising signal transfer wirings that are connected to the sensing electrodes to transfer the change in voltage of the resistive films.

3. The touch screen as set forth in claim 1, wherein the grooves are formed along the outer regions of the resistive films at the same interval.

4. The touch screen as set forth in claim 1, wherein the groove passes through the base member.

5. The touch screen as set forth in claim 1, wherein the groove has a slit shape formed along the outer region of the resistive film.

6. The touch screen as set forth in claim 1, wherein the resistive film is made of a conductive polymer.

7. A touch screen, comprising:
a pair of base members that are spaced apart from each other by a spacer and have a plurality of electrode patterns formed on the opposite surfaces thereof to intersect with each other;
grooves that are formed in outer regions of the electrode patterns and are extended from the upper surfaces of the electrode patterns to the base members in a thickness direction; and
sensing electrodes that are formed in the outer regions of the electrode patterns to cover the grooves and are filled in the grooves.

8. The touch screen as set forth in claim 7, further comprising signal transfer wirings that are connected to the sensing electrodes to transfer the change in capacitance of the electrode patterns.

9. The touch screen as set forth in claim 7, wherein the groove passes through the base member.

10. The touch screen as set forth in claim 7, wherein the electrode pattern is made of a conductive polymer.
